(19) United States
(12) Patent Application Publication
(10) Pub. No.: US 2008/0081222 A1
(43) Pub. Date: Apr. 3, 2008

(54) HELIATOMIC Generator

(76) Inventor: Marcus Ray Taylor, Castro Valley, CA (US)

Correspondence Address: MARCUS R. TAYLOR, 18508 MOUNTAIN LANE, CASTRO WAY, CA, 94552, US

(21) Appl. No.: 11/537,604

(22) Filed: Sep. 29, 2006

(51) Int. Cl. H01M 14/00

(52) U.S. Cl. 429/5

(57) ABSTRACT

A nuclear electric generator which utilizes particles produced during the spontaneous disintegration of selected radioisotopes as a means of generating electricity and production of coolant and insulating material. The apparatus shall consist of an alpha emitting radioisotope diffused within or sandwiched between a first lead plate. The alpha particles capture two electrons and exit as helium atoms, resulting in a high positive charge. A beta emitting radioisotope shall be diffused within or sandwiched between a second lead plate, thus acquiring a high negative charge as a result of being “pumped” full of electrons. The entire apparatus will be immersed into a bath of liquid helium which will act as an insulator and remove heat generated by radioactive emissions. The positive and negatively charged plates shall be connected, externally, to a resistive load chosen for the voltage level desired.

### BACKGROUND

Electrical Generators have been with mankind for sometime. In 1831 Michael Faraday produced the first documented direct current (DC) electric generator. By the time of the 1880's, William Stanley of the United States, along with Mr. Gaulard and Mr. Gibbs of Europe, devised the first alternating current (AC) system of power generation. On Sep. 4, 1882, Thomas A. Edison began the first U.S. Central station power plant with 59 customers, and the rest, as they say, is history. Up until the advent of nuclear power, the majority of electric generating systems were powered either by water, or the burning of fossil fuels. When gas, diesel fuel oil and coal were cheap, there were very few problems. However, with the emphasis on our environment and the pollution that results from the previously mentioned activities, mankind was forced to find another way to satisfy his ever escalating need for electrical power.

Nuclear Power seemed to answer our immediate and future need for electricity. The generation of electricity was still accomplished by massive generators weighting hundreds of tons, but the water or fossil fuels used to turn these generators was replaced by the power of the atom. The rapid conversion of mass into energy and the ensuing heat that is the result of a nuclear explosion was found to be controllable. If the slow neutrons could be moderated such that the pace of the nuclear reaction was slowed to a safe level, then a substance such as sodium, or any number of agreeable elements, could be heated in a closed system which in itself would be exposed to water. Of course the water would become superheated and turn into steam, this steam would be used to turn massive turbines which, through mechanical linkage, would engage the aforementioned generators and produce electricity for public consumption.

While nuclear powered electric generators appeared to be a boon to mankind, there were some serious problems with this technology that could not be ignored. What do you do with the highly radioactive waste, where do you place these plants, so as not to endanger the general public if something went wrong. One fact is glaringly clear, from coal to nuclear power we have not really changed at all!

As if time stood still for over a hundred years, we are still using a source of high heat (coal, gas, nuclear reactions), to eventually raise water to its boiling point in order to produce steam. And this superheated steam is still turning turbines and generators to produce electricity. It is a fundamental fact of power generation that fully two-thirds of the energy used to produce electricity by fossil fuels or nuclear reactions is lost through heat dissipation. So in effect, we are continuing to operate as though we were in the late 1880's. There has been no fundamental change in the way in which we produce electricity for the masses, we have in reality replaced one inefficient heat producing method with another and called it progress.

Numerous devices for generating electrical energy from radioactive decay products have been patented by others with a modicum of success. Almost all of the devices utilized a single decay by-product or emitter as a source of fuel. Linder; U.S. Pat. No. 2,548,225 and 2,552,050, Brown; U.S. Pat. No. 4,835,433, Ginell; U.S. Pat. No. 3,290,522 and Ritter; U.S. Pat. No. 4,178,524 respectively call for either alpha, beta or gamma particle emitter fuel sources as a means of generating an electric current. Since these devices rely solely upon a single type of particle emission and do not take into account the secondary particles emitted, they are very inefficient and unlikely to entertain widespread use. Smith; U.S. Pat. No. 5,111,099 has the right idea in-so-far as utilizing all radioactive emissions available from a given radioactive source. However he states . . . “Structure is provided to permit removal of gaseous by-product from within the shell.” Helium would be the main gaseous by-product and instead of being removed, would be an integral part of the Heliatomic Generator. Further, Smith makes use of three mutually perpendicular magnetic fields to separate the alpha and beta particles and direct them to predetermined regions of his device thereby complicating what should be a fairly simple process. The Heliatomic Generator makes use of no magnetic fields to guide particles in a specific direction. Baskis; U.S. Pat. No. 5,825,839 appears to be on the right track, however nowhere is liquid helium used as an insulator to attain extremely high voltages and cryogenic cooling agent to allow the plates to acquire superconducting properties. In addition the plates are positioned “proximate the radioisotopes” whereas in my embodiment the radioisotopes are diffused within or sandwiched between a pair of lead plates allowing greater efficiency, since particles are ejected from said radioisotopes in all directions, absent a controlling magnetic field. Further the use of lead plates reduces any secondary gamma emissions. Further in my embodiment two specific radioisotopes are used for the generation of alpha and beta particles. These radioisotopes, Curium and Cesium, have secondary emissions (if any) which are identical to their primary emissions thus increasing efficiency and voltage. Virtually any other radioisotopes used will have secondary emissions that cancel out the primary emissions i.e., alpha particle emission followed by beta particle emission.

### DETAILED DESCRIPTION OF THE HELIATOMIC GENERATOR

Prior to discussing the operation of the Heliatomic Generator a review of the major items of importance, will help in acquiring a complete understanding of the generators' operation;

a) The element LEAD becomes superconducting at 7.19 degrees Kelvin and, due to its ability to absorb short wave-length radiation, is used as shielding in the nucleonic industry.

b) The element HELIUM is used to cool certain elements, lead being one, to a low enough temperature so that they become superconducting. In addition, liquid helium has the greatest heat transfer rate known to man and, by its very nature is also the greatest insulator in the known world. An electron injected into liquid helium reacts repulsively with the helium atoms, reduces its zero point energy by forming a cavity or bubble of 1.7 nm radius, within which it is confined.

c) ALPHA particles emitted from radioactive elements or isotopes are nothing but helium atoms with their two orbiting electrons stripped away. An Alpha particle injected into liquid helium will attract neutral helium atoms and form a “snowball”.

d) BETA particles are also emitted from radioactive elements or isotopes. Beta particles are nothing but electrons.

e) Voltage is determined by the potential difference between two points. In other words if there is an imbalance of electrons between two points, and one joule of work is required to force one coulomb of charge from one point to the other, you have one volt of potential difference.

f) Superconductivity is that state reached by an element wherein said element shows no resistance to an electric current whatsoever. A large enough magnetic field or large enough flow of current (which induces a magnetic field) will change a superconductor into its natural resistive state.

In constructing the Heliatomic Generator, so that it performs at its optimum, paramount importance must be paid to the radioisotopes used. The Alpha and Beta emitters should be matched in such a manner that a constant difference in potential will be maintained between the positive and negative nodes. Therefore, the half-life and the curie level of the radioisotopes involved must properly complement each other. As an example of “CURIE/HALF-LIFE” matching the Alpha emitter will be the radioisotope Curium-243.

### Curium-243

The chemical element Curium does not exist in the terrestrial environment, but may be produced artificially by the neutron irradiation of Americium-241, or the bombardment of plutonium with helium ions. Its Atomic Number is 96, and while its Atomic Mass can vary, it is the isotope “243” that we will use in this example of the Heliatomic generator. The atomic symbol of this isotope is “Cm” and Curium-243 has a half-life of 29 years. Cm-243 decays by alpha particle emission and approximately 87 percent of these particles have an energy level of around 5 Million Electron Volts (Mev.). The decay process is such;

$$96 Curium \text{-} 243 {{\to }_{29 years}}^{alpha decay} 94 Plutonium \text{-} 239$$

$$94 Plutonium \text{-} 239 {{\to }_{24 , 400 years}}^{alpha decay} 92 Uranium \text{-} 235$$

$$92 Uranium \text{-} 235 {{\to }_{7 \times 10 to the 8 th years}}^{alpha decay} 90 Thorium \text{-} 231$$

The decay of the Curium by alpha emission reduces the atomic mass by four (4) and the atomic number by two (2). The Plutonium decays by alpha emission within 2.4×10³ years and becomes Uranium-235 with an atomic number of 92. The Uranium decays by alpha emission into Thorium-231.
Now we must determine the number of disintegration's per second for a specific amount of Cm-243. In this example we will use one gram of the radioisotope Curium-243. Since one mole of any substance numerically equals the atomic weight of that substance in grams, and Avogadro's number indicates the actual number of elementary units in a mole, the following conclusions are reached;

1 mole of Curium-243=243 grams=6.022×10²³ atoms

1 gram of Curium-243=2.478×10²¹ atoms

Since the half-life (h/l) of Cm-243 is 29 years, then in that time period 1.239×10²¹ atoms will decay by alpha emission. Being that there are 9.145×10⁸ seconds in the aforementioned half-life, the division indicates that one gram of Cm-243 will experience.
1.3549×10¹² disintegration's per second on average.
   Metallic Curium has a silvery luster and has a melting point of approximately 1340 degrees centigrade (+40 degrees). Since the decay rate per second, per gram, has been established, it is obvious that the alpha particles emitted will ideally remove 2.7098×10¹² electrons each second from the surrounding material, in this case lead. A number of compounds of Curium are known however a metallic composition of Curium and lead drawn very thin and then sandwiched between two similarly thin sheets of pure lead will complete the physical construction of the positive node of this specific generator. As stated previously, the alpha particles (helium ions) will, in capturing two electrons, become a complete and stable helium atom. Since there are 1.3549×10¹² alpha particles emitted each second from one gram of Cm-243, it stands to reason that 1.3548×10¹² helium atoms will be formed in approximately the same time period.

Cesium-137

The chemical element Cesium is the heaviest of the alkali metals in group I of the periodic table. It is a soft, light, very low-melting metal. Cesium-137 is the radioisotope that will be used as the Beta particle emitter. It is available in large quantities in the reprocessing of fuel elements from nuclear reactors in addition hundreds of millions of curies of Cesium-137 is stored at the Savannah River Plant in South Carolina and at the Hanford reservation near Richland. The atomic number of Cesium is 55, it has a melting point of 28.5 degrees centigrade and its symbol is Cs. We will go through the same steps taken above to determine the average beta emission of Cesium-137. The decay process of Cesium-137 is such;

$$55 Cesium \text{-} 137 {{\to }_{30 years}}^{beta decay} 56 Barium \text{-} 137 ( stable )$$

The decay of the Cesium-137 as stated before is by Beta particles and decays to the stable isotope Barium-137. As stated previously, in accordance with Avogadro's number, the following conclusions are reached;

1 mole of Cesium-137=137 grams=6.022×10²³ atoms

1 gram of Cesium-137=4.395×10²¹ atoms

Since the half-life (h/l) of Cs-137 is 30 years, then in that time period 2.197×10²¹ atoms will decay by alpha emission. Being that there are 9.460×10⁸ seconds in the aforementioned half-life, the division indicates that one gram of Cs-137 will experience . . . 2.323×10¹² disintegration's per second on average.
Since the beta emission is approximately double the alpha emission, we can maintain a consistent difference in potential between the positive and negative nodes. In other words, when we remove two (2) electrons from the positive plate, due to alpha capture, we “inject” two (2) electrons into the negative plate through beta emission.
The positive plate containing the Curium-243 will be grounded during construction, as will the negative plate containing the Cesium-137. The plates will then be placed into a containment vessel capable of attaining and maintaining cryogenic temperatures. The vessel shall then be flooded with liquid helium under pressure. Once the plates have been saturated with the fluid, the “ground” will be removed. Since there is an open circuit between the positive and negative plates, with the removal of the “ground”, the following actions will occur;

a) The depletion of electrons from the positive plate, in one second, will be approximately (+)2.7098×10¹² electrons with respect to ground. Since each electron carries a charge of 1.602×10⁻¹⁹ coulombs, we have by conversion, a charge of (+)4.341×10⁻⁷ coulombs or 0.4341 uC (microcoulombs) with respect to ground.

b) The injection of electrons into the negative plate in one second will be approximately (−)2.323×10¹² electrons, which by conversion, results in a charge of (−)3.721×10⁻⁷ coulombs or 0.3721 uC with respect to ground.

In electrical theory, we are concerned with the potential difference between two points, rather than with their potential to “ground”. It is similar to an electric power supply wherein you have at terminal-(a) +5 volts, at terminal-(b) o volts (or ground) and at terminal-(c) −5 volts. The power supply provides a potential difference between terminals (a) and (c) of 10 volts. Therefore the total difference in charge between the positive and negative plates of this example of the Heliatomic Generator, in one second, is 8.062×10⁻⁷ coulombs or 0.8062 uC. It is assumed that the positively charged plate will represent the ground and the negatively charged plate (since it has an excess of electrons) will represent the point of higher potential. The Heliatomic Generator, due to its' unique configuration, will increase its potential difference, in the face of resistive loads, until a stabilizing flow of current is achieved.
Now, as stated before, the injection of electrons into the negative plate will be approximately (−) 2.323×10¹² electrons per second and the optimal performance of the Heliatomic Generator will require the removal of a like number of electrons from the positive plate This will result in a constant flow of 2.323×10¹² electrons through a wire, for a current of 3.721×10⁻⁷ amperes each second. The initial potential difference of the Heliatomic Generator will not be proportional to its current upon startup, instead, a voltage (EMF) of 7.442×10⁻⁷ volts will evidence itself within the first second. This is the result of the aforementioned removal of approximately 2.323×10¹² electrons from the positive plate, allowing an aggregate potential difference and voltage between the negative and positive nodes of approximately 7.442×10⁻⁷ volts with a current flow of 3.721×10⁻⁷ amperes across two ohms of resistance. Now while the current flow will attempt to remain constant, the voltage (EMF) will increase if the resistive load increases. The “voltage” will continue to increase until the initial current flow is attained through this new resistive load. With an open circuit between the negative and positive nodes, the following voltages will be achieved for this example of the Heliatomic Generator using a total of two grams of radioisotopes . . .

| TIME | VOLTAGE LEVEL | |
|---|---|---|
| one second | 7.442 × 10⁻⁷ | volts |
| one minute | 4.465 × 10⁻⁵ | volts |
| one hour | 2.679 × 10⁻³ | volts |
| one day | 6.429 × 10⁻² | volts |
| one week | 4.5 × 10⁻¹ | volts |
| one month (30 days) | 1.928 | volts |
| six months (180 days) | 11.57 | volts |

Now the voltage of 11.57 volts will be maintained with a constant amperage of 3.72×10⁻⁷ amperes if a resistive load equivalent to 31 megohms is placed between the positive and negative nodes. In order to fully appreciate the value of the Heliatomic Generator it must be compared to, and rated against, the device it is intended to replace . . . the average Nuclear Power Plant.

### Facts

Nearly all of the fission reactors in the United States (and most of the world) are of a type that employs ordinary water to moderate the nuclear reactor's “core”. The average operation of the nations nuclear power plants is about 58% of capacity over a life span of approximately 28-29 years. These nuclear power plants cost in the neighborhood of $5.5 Billion dollars to. construct and operate, and 10's of millions of dollars to decommission. The reactor core nominally contains about 100 Tons (200,000 pounds) of enriched uranium oxide (3%), and needs several other components, all expensive in nature and energy inefficient. Listed below is a representative comparison of the major components required for the average Nuclear Power Plant and the Heliatomic Generator

| NUCLEAR POWER PLANT | HELIATOMIC GENERATOR |
|---|---|
| Reactor Core (100 Tons) | Heliatomic Gen. Core (1 Ton) |
| Steam Generator | Refrigerator/Condenser |
| Turbines | Transformer |
| Electric Generators | Helium Storage Tank |
| Transformer | |
| Radioactive waste storage tank | |
| Condensate storage tank | |
| Cooling Tower | |

In addition the hazards associated with the average nuclear reactor lies in its inventory of radioactive waste. The reactor commences operation with a comparatively low level of radioactivity, but radioactive fission products gradually accumulates in the fuel rods. If the reactor has been at full power for at least a year or so, this accumulation of radioactivity would be on the order of 10 Billion curies, an amount equal to 10,000 tons of radium. The Heliatomic Generator however, commences with a high level of radioactivity and in approximately 30 years has reduced its radiation level by half, producing little or no radioactive by-products or waste.

### Now let us compute the electrical output of the Heliatomic Generator using an approximate total of one ton of the specified radioisotopes; goo pounds of Curium-243 and 1000 pounds of Cesium-317.

### Since one gram of Curium-243 has approximately 1.3549×10¹² disintegration's per second we arrive at the following statistics . . .

28 Grams=1 Ounce=3.7937×10¹³ dis/sec.

16 Ounces=1 Pound=6.0699×10¹⁴ dis/sec.

900 Pounds=5.462×10¹⁷ dis/sec.

and being that the radioactive emissions are Alpha Particles, we will remove a total of 1.0924×10¹⁸ electrons from the positive node in one second.

As for one gram of Cesium-137, it has approximately 2.323×10¹² disintegration's per second so the following statistics apply . . .

28 Grams=1 Ounce=6.504×10¹³ dis/sec.

16 Ounces=1 Pound=1.040×10¹⁵ dis/sec.

1000 Pounds=1.040×10¹⁸ dis/sec.

Following the reasoning used in the previous example of the Heliatomic Generator we arrive at a current flow of approximately 1.040×10¹⁸ electrons between the positive and negative nodes (or plates). This current flow is equivalent to 0.166 Amperes. In this example, if we have an open circuit between the two plates, the following voltages will be generated (remember that the electromotive force is approximately 0.33 volts);

| TIME | VOLTAGE LEVEL | |
|---|---|---|
| one second | 0.33 | volts |
| one minute | 19.8 | volts |
| one hour | 1,188 | volts |
| one day | 28,512 | volts |
| one week | 199,584 | volts |
| one month (30 days) | 855,360 | volts |
| six months (180 days) | 5,132,160 | volts |

Of course the output (5,132,160 volts) will have to be reduced to a manageable level for power transmission. This could be accomplished through the use of a step-down transformer, the voltage level will be maintained if the inductive/resistive/reactance value of the primary is equal to approximately 31 megaohms. If the ratio of windings in the primary and secondary is 50-to-1, the voltage would be reduced to approximately 102,643 volts and the current would be increased to 8.3 amperes (in an ideal transformer), which is quite appropriate for long distance power transmission.

### Heat

It is obvious that the amounts of radioisotopes discussed are literally “to hot to handle”, both radioactively and thermally. We discussed the containment of the radioactive emissions by sandwiching or dispersing the radioisotopes within or between lead plates thick enough to inhibit the escape of nuclear particles into the surrounding atmosphere (i.e. the containment vessel). As for the immense heat generated by the kinetic energy of the radioactive emissions, the following explanation of the application of liquid helium and the design of the lead plates will ensure the maximum removal possible of any heat generated through conduction and/or radiation. If you placed a very thin sheet of metal, with a surface area of four square feet, over a red hot coal of approximately one cubic inch in size, and then positioned your hand directly over the area covering the hot coal, you would quickly remove your hand or run the risk of a severe burn. However, if you were to pulverize the red hot coal, and spread it equally over an area of four square feet, you could place the same sheet of metal over the coal fragments and barely feel a rise in temperature. This is exactly how the distribution of the selected radioisotopes will be handled vis-a-vis their placement between the lead plates of the Heliatomic Generator. One method of construction could entail having the lead plates drawn to a thickness of several millimeters, prohibiting the passage of any alpha or beta particles at cryogenic temperatures. The surface area of the thinly drawn lead would be extremely large. Upon this large surface area the respective radioisotope would be equally distributed. A similar sheet of lead would be placed atop the radioisotope bearing sheet and “sandwiched” together under high pressure. An alternative method would be to “draw” a compound of lead and the selected radioisotope into a very thin sheet and place this material between the lead plates under pressure. What is important is that the radioisotope be distributed over a large area so that the “heat” from the kinetic energy is absorbed and there are enough free electrons available for capture by the alpha particles, until the desired voltage is reached The respective lead “sandwiches” will have hundreds of pin holes per square inch, in order to facilitate the cooling process as the liquid helium is introduced into the containment vessel. Further, if the lead “sandwiches” were rolled into a helical cylinder, much like a rolled up newspaper, with space between adjacent “turns”, the liquid helium would saturate both surfaces of the lead plates and cross sections of the interior for optimum heat transfer and electrical insulation.

### Conclusion

The Heliatomic Generator is based upon the laws of physics and known scientific principles. What is unique and patentable is the ‘process’ of combining these principles in such a manner as to produce electricity at a controllable level for an economically profitable period of time. The production of electricity by this method can be reduced to the following operations;

A) Acquire an Alpha emitting radioisotope of a desired curie level and imbed or sandwich it between lead plates or sheets.

B) Acquire a Beta emitting radioisotope of an amount such that the curie or emission level is twice that of the alpha emitter, and the respective radioisotopes have similar half-lives. Imbed or sandwich this radioisotope between lead plates or sheets.

C) Place the negative (Beta) plate and the positive (Alpha) plate into a common, or separate containment vessels (while maintaining a ground for each) and introduce into the vessel liquid helium which will act as a heat transfer agent and electrical insulator.

D) Allow the charges to build up to the desired voltage level by routing the closed circuit through an inductive/resistive/reactance value appropriate for the voltage level desired.

With the Heliatomic Generator there are no radioactive by-products, merely radioactive decay isotopes which can be separated, irradiated and used again. In fact, if the containment vessels are “standardized” in so far as design and size are concerned, then instead of decommissioning the plant after 30 years (the useful half-life of the selected radioisotopes), we could simply shut down the power plant, remove the old depleted containment vessels and install new ones with new or recycled radioisotopes. With the implementation of this process mankind truly leaves the age of fire behind, and enters an era where the direct conversion of Nuclear energy into electricity for the masses is a reality.

While the preferred embodiment of the Heliatomic Generator has been described, it is apparent that there are many variations as to the structure of the apparatus and the radioisotopes used. Anyone skilled in the art will realize that numerous changes can be made to the Heliatomic Generator without departing from the spirit of the invention or exceeding the scope of the appended claims.

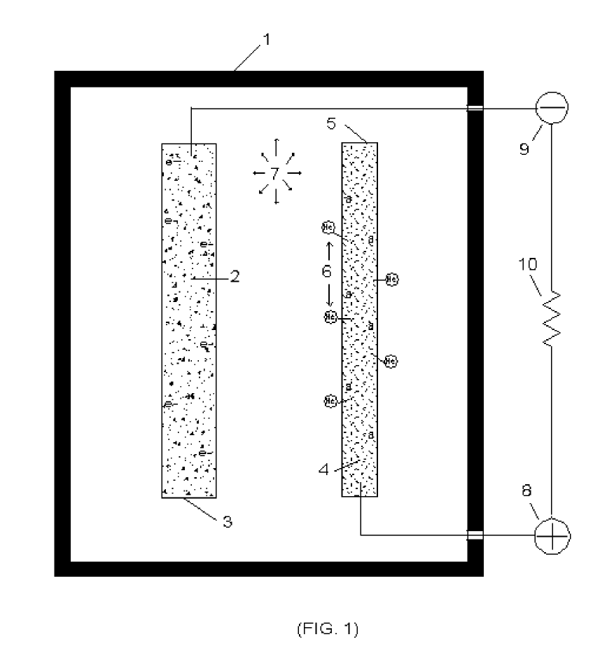

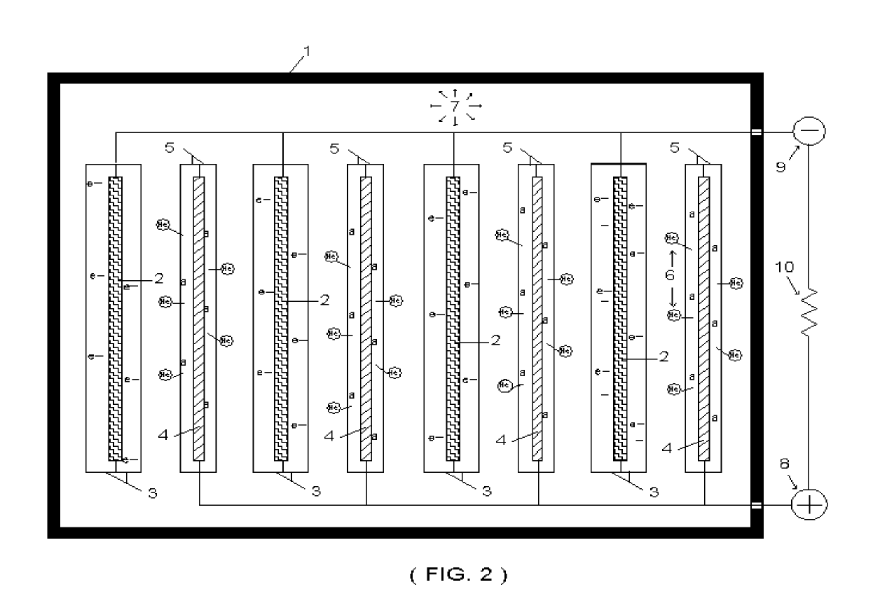

### DESCRIPTION OF HELIATOMIC GENERATOR AS DEPICTED IN FIG. 1 AND FIG. 2

FIG. 1. illustrates one aspect of the Heliatomic Generator as described in the application. This version of the generator consists of (1) a container capable of attaining and sustaining cryogenic temperatures under pressure. Cesium, the Beta emitting radioisotope (2) is diffused within lead plate (3) which has a thickness exceeding the range of an electron at maximum radioisotope energy. Plate (3) will become highly negatively charged due to the excess of electrons/beta particles (e-) and comprise the negative node (9) via electrical conductor. Curium, the Alpha emitting radioisotope (4) is diffused within lead plate (5) with a thickness exceeding the range of 5 Mev Alpha particles. The Alpha particles (a) will capture two electrons from the lead plate (5) and exit said plate as Helium atoms (6). The lead plate (5) due to being deficient in electrons will acquire a high positive charge and represent the positive node (8) via electrical conductor. The Helium atoms and/or molecules will supplement the liquid helium bath (7) that is used as an insulator and cooling agent. The positive node (8) and the negative node (9) shall have a resistive load (10) chosen for the desired voltage level connecting each other. The electron flow shall proceed from the level of higher potential difference, i.e., the negatively charged plate (3) with the excess of electrons into the positively charged plate (5) that is deficient in electrons through the electrical conductor and resistive load (10).

FIG. 2. illustrates another aspect of the Heliatomic Generator as described in the application. This version of the generator consists of (1) a container capable of attaining and sustaining cryogenic temperatures under pressure. Cesium, the Beta emitting radioisotope (2) is sandwiched between a plurality of electrically connected lead plates (3) which have a thickness exceeding the range of an electron at maximum radioisotope energy. The plates (3) will become highly negatively charged due to the excess of electrons/beta particles (e-) and comprise the negative node (9) via electrical conductor. Curium, the Alpha emitting radioisotope (4) is sandwiched between a plurality of electrically connected lead plates (5) with a thickness exceeding the range of 5 Mev Alpha particles. The Alpha particles (a) will capture two electrons from the lead plates (5) and exit said plates as Helium atoms (6). The lead plates (5) due to being deficient in electrons will acquire a high positive charge and represent the positive node (8) via electrical conductor. The Helium atoms and/or molecules will supplement the liquid helium bath (7) that is used as an insulator and cooling agent. The positive node (8) and the negative node (9) shall have a resistive load (10) chosen for the desired voltage level connecting each other. The electron flow shall proceed from the level of higher potential difference, i.e., the negatively charged plates (3) with the excess of electrons into the positively charged plates (5) that is deficient in electrons through the electrical conductor and resistive load (10).

What is claimed is:

1) A radioisotope powered electric generator comprising
a positive node having the radioisotope curium-243 sandwiched between or diffused within a first lead plate, with said lead plate having a thickness exceeding the range of 5 Mev alpha particles;
a negative node having the radioisotope cesium-137 sandwiched between or diffused within a second lead plate, with said lead plate having a thickness exceeding the range of an electron at maximum radioisotope energy;
liquid helium disposed between the first and second lead plates as an electrical insulation and cooling agent;
and means of connecting said first and second lead plates together by a resistive load to attain and maintain a voltage level.

2) A radioisotope powered electric generator as in claim 1 wherein the Positive node shall comprise a plurality of spaced first plates electrically connected together and the negative node shall comprise a plurality of spaced second plates electrically connected together.

3) A radioisotope powered electric generator as in claim 1 wherein the lead plates consisting of the positive node and the lead plates Consisting of the negative node are allowed to become superconducting.
